(19) United States
(12) Patent Application Publication
(10) Pub. No.: US 2025/0373122 A1
(43) Pub. Date: Dec. 4, 2025

(54) OIL SUCTION DEVICE

(71) Applicant: HYUNDAI MOBIS CO., LTD., Seoul (KR)

(72) Inventor: Dae Wook KIM, Yongin-si (KR)

(73) Assignee: HYUNDAI MOBIS CO., LTD., Seoul (KR)

(21) Appl. No.: 19/197,108

(22) Filed: May 2, 2025

(30) Foreign Application Priority Data
Jun. 4, 2024 (KR) 10-2024-0072876

(51) Int. Cl. H02K 9/193

(52) U.S. Cl. CPC H02K 9/193

(57) ABSTRACT

The present disclosure relates to an oil suction device applied to a sump space of a vehicle. According to the oil suction device of the present disclosure, by adding the flow control unit for controlling suction resistance of oil suctioned to the supply pipe, it is possible to reduce a difference in oil level, reduce no-load loss and loss during rotation of the rotor by reducing a rise in oil level of the end plate, improve cooling performance of the motor by keeping the sump space from running out of oil, and at the same time, maintain the reduction effects for reducing the cost and reducing the packing size and weight, which are the trend of conventional motors.

### CROSS REFERENCE TO RELATED APPLICATION

The present application claims priority to Korean Patent Application No. 10-2024-0072876, filed Jun. 4, 2024, the entire contents of which is incorporated herein for all purposes by this reference.

### BACKGROUND OF THE DISCLOSURE

### Field of the Disclosure

In tilting conditions of an EDU system for reflecting turning and climbing conditions of a vehicle, a sump space needs to be essentially positioned in the middle of an oil circulation space. When separating spaces of a motor and a reducer, there are cases in which the sump space is positioned in the middle of the motor, but to reduce the cost by omitting a sealing configuration and increase efficiency by reducing torque loss (no-load loss), and as the motor-reducer space is opened using an on-axis, the sump space is positioned in the middle of the oil circulation space, that is, at a lower end of a middle housing.

However, since the sump space is positioned in the middle housing, a distance between an end plate and an end space, which is an internal space of the end plate, is long. In addition, a flow cross-sectional area of an oil flow path from the end to a suction space is also folded to reduce the cost, weight, and packaging size. Accordingly, when suctioning oil, an oil pump intensively suctions the oil in a space of the middle housing, and oil introduced from the end plate has a load caused by suction resistance, and thus has a significantly reduced suction strength compared to oil introduced from the middle housing.

However, since the end plate and the middle plate have the same cooling structure, oil is sprayed evenly to both the end plate and the middle plate, and an imbalance occurs in the amount of oil remaining in the end plate and the middle plate. Accordingly, when the motor is driven for a long time, there is a problem that an oil level of the end plate increases and an oil level of the middle plate decreases.

Due to the above problem, churning loss occurs, and when a rotor tilts, oil cannot be suctioned in the middle housing in which the oil level is relatively low, resulting in a significant decrease in the cooling performance of the motor.

In addition, since a 2-speed reducer is applied to the motor and the reducer is longer, it is difficult to resolve imbalance in an oil level even when the suction space is positioned in the middle and formed as close to the reducer as possible, and thus it is difficult to suction the oil in the middle housing under both left and right turning conditions.

### DOCUMENT OF RELATED ART

(Patent Document 1) Korean Laid-Open Patent No. 10-2022-0045317 tilted “oil recovery structure for cooling motor” published on Apr. 12, 2020.

### DESCRIPTION OF THE RELATED ART

The present disclosure has been made in efforts to solve the above problems and is directed to providing an oil suction device, in which, by adding a flow control unit for controlling suction resistance of oil suctioned to a supply pipe, it is possible to reduce a difference in oil level, reduce no-load loss and loss during rotation of a rotor by reducing a rise in oil level of an end plate, improve cooling performance of a motor by keeping a sump space from running out of oil, and at the same time, maintain the reduction effects for reducing the cost and reducing the packing size and weight, which are the trend of conventional motors.

To solve the above problems, an oil suction device provided in a sump space at a lower end of a middle plate of a motor according to one embodiment of the present disclosure includes a supply pipe of which one end is open to the sump space and the other end communicates with an oil pump of the motor to suction oil flowing into the sump space and transfer the suctioned oil to the oil pump of the motor, and a flow control unit coupled to one end of the supply pipe, including a space in which the oil flows, and configured to control a flow volume of the oil suctioned to the supply pipe.

In addition, one surface of the sump space, in which an oil inflow hole through which oil of an end plate of the motor is introduced is formed, faces one surface of the flow control unit, and the flow control unit includes a first hole formed to pass through one surface thereof.

In addition, the other surface of the flow control unit is closed.

In addition, the flow control unit includes a second hole formed to pass through the other surface thereof, and the first hole and the second hole are connected.

In addition, an open area of the first hole is greater than an open area of the second hole.

In addition, the first hole is formed to linearly pass through the flow control unit in an axial direction of the motor, and the second hole is formed to pass through the flow control unit so as to include at least one curved section.

In addition, the first hole is formed at a position corresponding to a position at which the oil inflow hole is formed, and is formed at a position spaced a predetermined distance from the position at which the oil inflow hole is formed in an axial direction of the motor.

In addition, a distance between the one surface of the flow control unit and the one surface of the sump space is shorter than a distance between the other surface of the flow control unit and the other surface of the sump space.

In addition, the supply pipe includes an opening having one end into which the flow control unit is inserted, and the opening is open to a side opposite to a side that is open to an internal space of the middle plate of the sump space and formed to expand in a funnel shape.

In addition, the opening is formed to extend toward one surface of the sump space with respect to one end of the supply pipe.

### SUMMARY OF THE DISCLOSURE

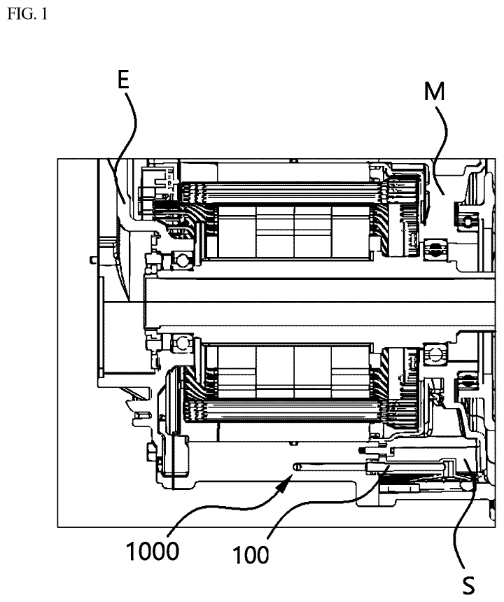

FIG. 1 is a partial cross-sectional view of a motor to which an oil suction device of the present disclosure is applied.

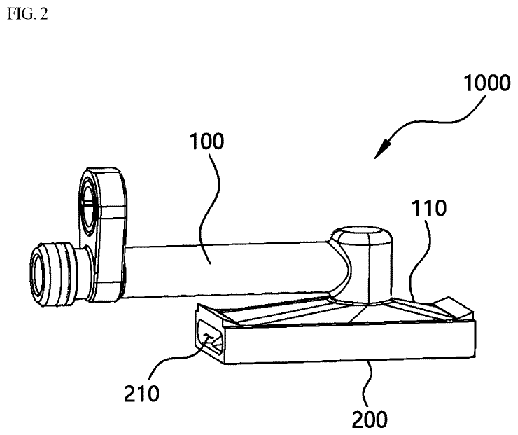

FIG. 2 is a perspective view illustrating the oil suction device of the present disclosure.

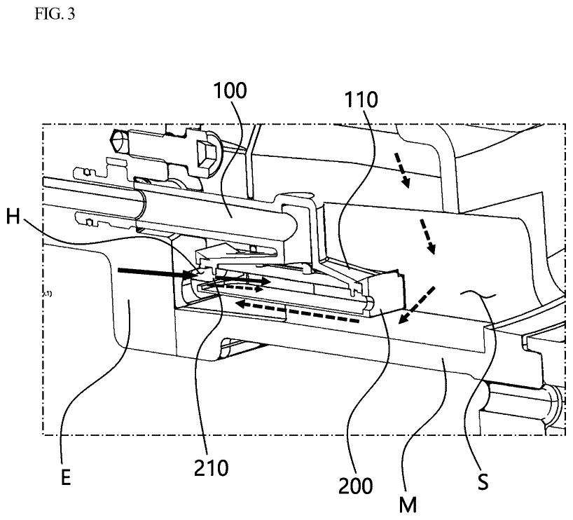

FIG. 3 is a partial perspective view of the motor to which a first embodiment of a flow control unit of the present disclosure is applied.

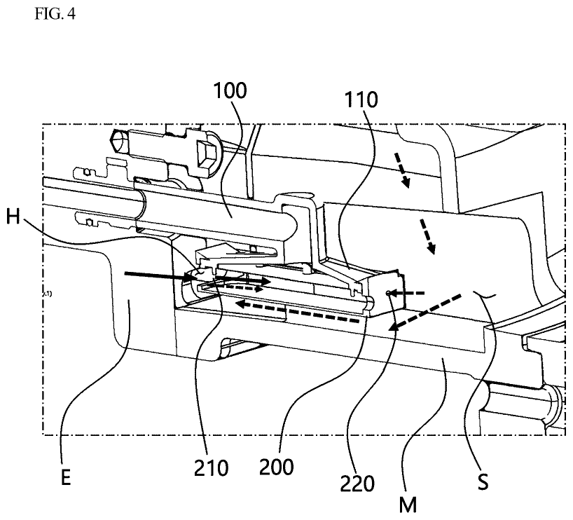

FIG. 4 is a partial perspective view of the motor to which a second embodiment of the flow control unit of the present disclosure is applied.

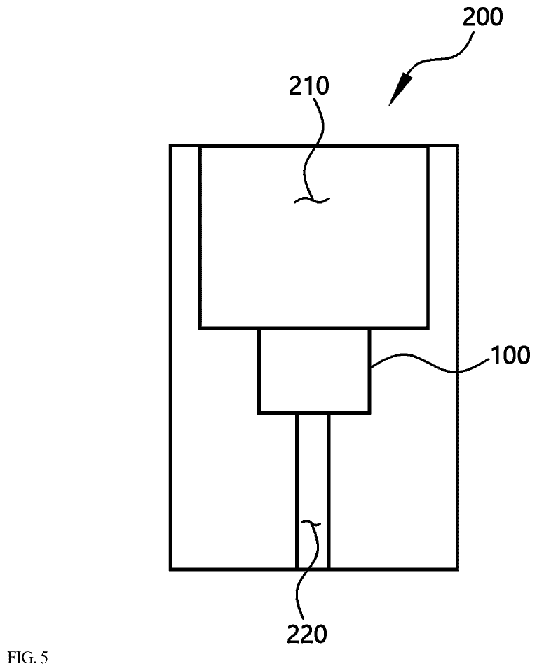

FIG. 5 is a schematic view illustrating a 2-1 embodiment of the flow control unit of the present disclosure.

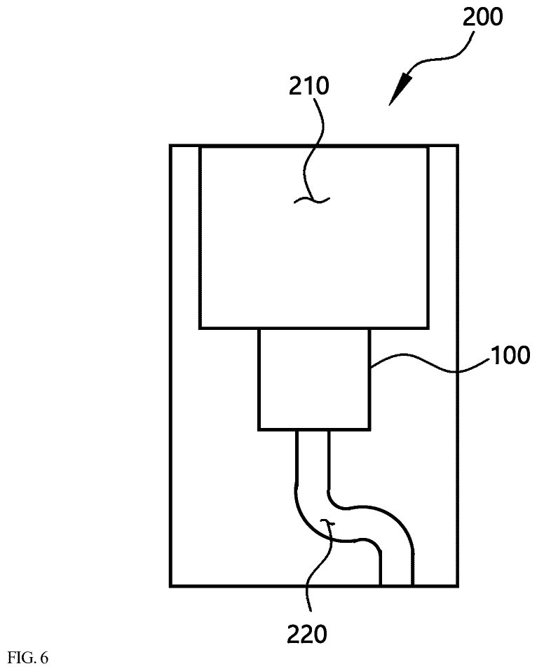

FIG. 6 is a schematic view illustrating a 2-2 embodiment of the flow control unit of the present disclosure.

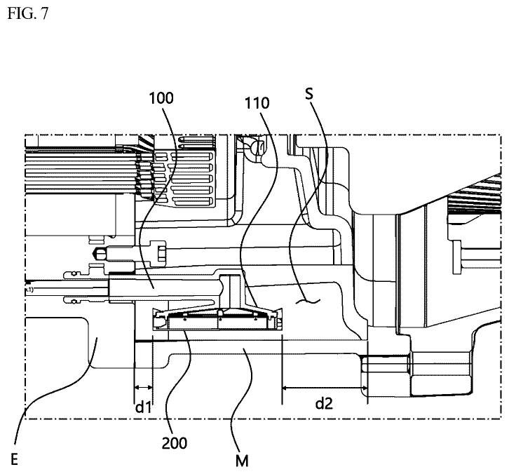

FIG. 7 is a partial cross-sectional view of a sump space of the motor to which the oil suction device of the present disclosure is applied.

### BRIEF DESCRIPTION OF THE DRAWINGS

Hereinafter, the technical spirit of the present disclosure will be described in more detail with reference to the accompanying drawings. Prior to this, terms or words used in this specification and claims should not be interpreted as limited to their usual or dictionary meanings and should be interpreted as meanings and concepts that conform to the technical idea of the present disclosure based on the principle that the inventor can appropriately define the concepts of the terms in order to describe his or her own disclosure in the best way.

Hereinafter, a basic configuration of an oil suction device 1000 of the present disclosure will be described with reference to FIGS. 1 and 2.

As illustrated in FIG. 1, an oil suction device 1000 of the present disclosure is provided in a sump space S at a lower end of a middle plate M of a motor and may include a supply pipe 100 that transfers oil of the sump space S to an oil pump illustrated in FIG. 2. More specifically, the supply pipe 100 may have one end open to the sump space S, and the other end communicating with the oil pump of the motor. The supply pipe 100 may include a nozzle that generates a flow volume for suctioning oil inside one end thereof. Accordingly, the supply pipe 100 may suction the oil inside the sump space S and transfer the suctioned oil to the oil pump of the motor. In this case, the sump space S may communicate with an internal space of the middle plate M of the motor and may be provided at a lower end of the middle plate M based on a phase mounted on a vehicle.

In addition, as illustrated in FIG. 2, the oil suction device 1000 of the present disclosure may include a flow control unit 200. The flow control unit 200 is a component that is injection-molded as a single component and may include a polymer material. The flow control unit 200 may be coupled to one end of the supply pipe 100, may include a space in which oil flows, and may control the flow volume of oil suctioned to the supply pipe 100. More specifically, oil transferred from an end plate E side based on the supply pipe 100 may be suctioned with low resistance and oil transferred from an opposite side may be suctioned with high resistance so that oil introduced through a flow path from the end plate E is preferentially suctioned inside the sump space S (oil introduced from the middle plate is regularly present in the sump space S), thereby eliminating imbalance between a flow volume of the oil introduced from the end plate E and a flow volume of the oil introduced from the middle plate. Ultimately, churning loss and no-load loss can be reduced so that a motor cooling system is smoothly operated even when the motor tilts.

Hereinafter, a specific configuration of the flow control unit 200 and the supply pipe 100 of the present disclosure will be described in more detail with reference to FIGS. 3 to 7. The flow control unit 200 may be referred to as a flow controller. The flow control unit 200 according to an exemplary embodiment of the present disclosure may be a hardware device implemented by various electronic circuits (e.g., computer, microprocessor, CPU, ASIC, circuitry, logic circuits, etc.). The processor may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

As illustrated in FIG. 3, the flow control unit 200 may be provided so that one surface thereof faces one surface of the sump space S in which an oil inflow hole H through which the oil of the end plate is introduced is formed. In addition, the flow control unit 200 may include a first hole 210 formed to pass through one surface thereof. By providing the first hole 210 to face the oil inflow hole, the oil introduced from the end plate E side may be introduced directly through the first hole 210 (solid-line arrows), while the oil of the middle plate, which regularly flows into the sump space S, may be guided to flow along a complex path so as to flow into the flow control unit 200, furthermore, into one end side of the supply pipe 100 (dotted-line arrows).

In addition, the first hole 210 may be formed at a position corresponding to a position at which the oil inflow hole H is formed and formed at a position spaced a predetermined distance from the position at which the oil inflow hole H is formed in an axial direction of the motor. Accordingly, the oil at the end plate E side discharged from the oil inflow hole may directly flow into the first hole 210, and suction flow resistance can be minimized.

In this case, in a first embodiment of the flow control unit 200, the other surface of the flow control unit 200 is closed. Accordingly, the oil flowing into the sump space S from the middle plate side may be introduced only through the first hole 210, and the flow resistance of the oil introduced from the middle plate side can be further increased during suction.

In addition, in a second embodiment of the flow control unit 200 illustrated in FIG. 4, the flow control unit 200 may include a second hole 220 formed to pass through the other surface thereof, and the first hole 210 and the second hole 220 may be connected. Accordingly, the oil introduced from the end plate E side may be directly introduced through the first hole 210 (solid-line arrows), while the oil of the middle plate, which regularly flows into the sump space S, may be guided to flow along a complex path so as to flow into the flow control unit 200, furthermore, into one end side of the supply pipe 100 or may be introduced through the second hole 220 formed to pass through the other surface of the flow control unit 200 (dotted-line arrows).

In this case, in a 2-1 embodiment of the flow control unit 200 illustrated in FIG. 5, an open area of the first hole 210 may be greater than an open area of the second hole 220. Since most of the oil introduced from the end plate E side is suctioned through the first hole 210, most of the oil introduced through the second hole 220 is oil of the middle plate. Accordingly, by configuring the open area of the second hole 220 to be significantly smaller than the open area of the first hole 210, it is possible to prevent a large amount of oil from being introduced from the middle plate side.

In the 2-1 embodiment of the flow control unit 200, since the other surface of the flow control unit 200 is not completely closed but is partially opened through the second hole 220, it is possible to prevent resistance of the oil introduced from the middle plate from excessively increasing. Accordingly, the oil at the end plate E side and the oil at the middle plate side can be uniformly suctioned to the supply pipe 100, and even when a suction strength increases, it is possible to prevent an excessively large load from being applied to the flow control unit 200.

In addition, in a 2-2 embodiment of the flow control unit 200 illustrated in FIG. 6, the first hole 210 may be formed to linearly pass through the flow control unit 200 in the axial direction of the motor, and the second hole 220 may be formed to pass through the flow control unit 200 so as to include at least one curved section. Accordingly, the flow resistance of the oil introduced through the second hole 220, that is, the oil introduced from the middle plate, can be increased during suction. In this case, in one example of use, when the design of the second hole 220 is changed and applied, suction resistance of the oil at the end plate E side and suction resistance of the oil at the middle plate side may be adjusted to be substantially the same.

As illustrated in FIG. 7, a distance d1 between one surface of the flow control unit 200 and one surface of the sump space S may be shorter than a distance d2 between the other surface of the flow control unit 200 and the other surface of the sump space S. That is, by bringing the one surface of the flow control unit 200 closer to the oil inflow hole H, the suction resistance for the oil introduced from the end plate E side can be further reduced, and the suction resistance for the oil introduced from the middle plate side can be further increased.

In addition, as illustrated in FIG. 7, the supply pipe 100 may include a funnel-shaped opening 110 formed at one end thereof. The opening 110 may be assembled by inserting the flow control unit 200 into one end thereof, and a predetermined step may be formed to protrude from the opening 110 so that the flow control unit 200 may be assembled. In addition, the opening 110 may be opened to a side opposite to the side that is open to the internal space of the middle plate M of the sump space S. In this case, a surface of the flow control unit 200 (a surface perpendicular to one surface and the other surface thereof) at the side to which the opening 110 is open may be closed. Accordingly, oil may be suctioned only through the first hole 210 or the second hole 220 formed in the one surface and the other surface of the flow control unit 200, and the flow of oil can be controlled more minutely.

In this case, a length of the opening 110 extending toward one surface of the sump space S may be larger than a length of the opening 110 extending toward the other surface based on one end of the supply pipe 100. Accordingly, the one surface of the flow control unit 200 may be provided closer to the oil inflow hole H side, and inclination of the opening 110 at the end plate E side may be formed to be more gently than inclination at the opposite side, thereby reducing the suction resistance of the oil introduced from the end plate E side, that is, the oil introduced from the end plate E.

In addition, the main goal of the present disclosure is to adjust the oil level of the end plate E and the middle plate M, but through the present disclosure, a difference in oil level between the reducer and the motor can also be made possible in the future. For example, the oil level of the reducer can be decreased to reduce churning loss, and the oil level at the motor side can be kept slightly higher for low-oil cooling. More specifically, the oil suction device 1000 of the present disclosure may be installed so that the first hole 210 is positioned at the reducer side and the second hole 220 is positioned at the middle plate M side and the end plate E side. In this case, specific sizes and positions of the first hole 210 and the second hole 220 may be selected through analysis and testing.

According to the oil suction device of the present disclosure according to the above configuration, by adding the flow control unit for controlling suction resistance of oil suctioned to the supply pipe, it is possible to reduce a difference in oil level, reduce no-load loss and loss during rotation of the rotor by reducing a rise in oil level of the end plate, improve cooling performance of the motor by keeping the sump space from running out of oil, and at the same time, maintain the reduction effects for reducing the cost and reducing the packing size and weight, which are the trend of conventional motors.

The technical spirit of the present disclosure should not be construed as limited to the above-described embodiments. Not only the scope of applications is diverse, but also various modifications may be made by those skilled in the art without departing from the gist of the present disclosure as claimed in the claims. Therefore, these improvements and changes fall within the scope of the present disclosure as long as they are obvious to those skilled in the art.

What is claimed is:

1. An oil suction device provided in a sump space at a lower end of a middle plate of a motor, the oil suction device comprising:
a supply pipe of which one end is open to the sump space and the other end communicates with an oil pump of the motor to suction oil flowing into the sump space and transfer the suctioned oil to the oil pump of the motor; and
a flow controller coupled to one end of the supply pipe, including a space in which the oil flows, and configured to control a flow volume of the oil suctioned to the supply pipe.

2. The oil suction device of claim 1, wherein one surface of the sump space, in which an oil inflow hole through which oil of an end plate of the motor is introduced is formed, faces one surface of the flow controller, and
the flow controller includes a first hole formed to pass through one surface thereof.

3. The oil suction device of claim 2, wherein the other surface of the flow controller is closed.

4. The oil suction device of claim 2, wherein the flow controller includes a second hole formed to pass through the other surface thereof, and
the first hole and the second hole are connected.

5. The oil suction device of claim 4, wherein an open area of the first hole is greater than an open area of the second hole.

6. The oil suction device of claim 4, wherein the first hole is formed to linearly pass through the flow controller in an axial direction of the motor, and
the second hole is formed to pass through the flow controller so as to include at least one curved section.

7. The oil suction device of claim 2, wherein the first hole is formed at a position corresponding to a position at which the oil inflow hole is formed, and
is formed at a position spaced a predetermined distance from the position at which the oil inflow hole is formed in an axial direction of the motor.

8. The oil suction device of claim 2, wherein a distance between the one surface of the flow controller and the one surface of the sump space is shorter than a distance between the other surface of the flow controller and the other surface of the sump space.

9. The oil suction device of claim 1, wherein the supply pipe includes an opening having one end into which the flow controller is inserted, and
the opening is open to a side opposite to a side that is open to an internal space of the middle plate of the sump space and formed to expand in a funnel shape.

10. The oil suction device of claim 9, wherein the opening is formed to extend toward one surface of the sump space with respect to one end of the supply pipe.
